(19) United States
(12) Patent Application Publication
(10) Pub. No.: US 2019/0375164 A1
(43) Pub. Date: Dec. 12, 2019

(54) BONDED BODY

(71) Applicant: DENSO CORPORATION, Kariya-city (JP)

(72) Inventors: Takashi SAKURADA, Kariya-city (JP); Shota Terachi, Kariya-city (JP); Masaya Nakamura, Kariya-city (JP)

(21) Appl. No.: 16/546,484

(22) Filed: Aug. 21, 2019

Related U.S. Application Data
(63) Continuation of application No. PCT/JP2018/004033, filed on Feb. 6, 2018.

(30) Foreign Application Priority Data
Mar. 31, 2017 (JP) 2017-069610

(51) Int. Cl. B29C 65/06; B29C 65/00

(52) U.S. Cl. CPC B29C 65/06; B29L 2031/7492; B29C 66/301; B29C 66/322

(57) ABSTRACT

A bonded body formed by a vibration welding of a first member and a second member. The first member includes a first base portion extending along an edge on the second member side, and a first welded portion which protrudes from the first base portion toward the second member. The second member includes a second base portion extending along an edge on the first member side and disposed to face the first base portion, and a second welded portion protruding from the second base portion toward the first member side, and a distal end of which is vibration welded to the distal end of the first welded portion. The first member has a rib for covering the first welded portion and the second welded portion from the side, and the rib is formed so as to protrude from the first base portion toward the second member side at a position separated from the first welded portion.

### CROSS REFERENCE TO RELATED APPLICATIONS

This application is a continuation application of International Patent Application No. PCT/JP2018/004033 filed on Feb. 6, 2018, which designated the U.S. and based on and claims the benefits of priority of Japanese Patent Application No. 2017-069610 filed on Mar. 31, 2017. The entire disclosure of all of the above applications is incorporated herein by reference.

### TECHNICAL FIELD

The present disclosure relates to a bonded body formed by vibration welding a plurality of members.

### BACKGROUND

In a case where a product having a relatively complicated shape is formed by resin, a plurality of members are formed in advance, and the product (bonded body) is formed by a vibration welding of these members.

### SUMMARY

The present disclosure provides a bonded body that is capable of sufficiently securing a movable range during vibration welding.

The bonded body according to the present disclosure is a bonded body formed by vibration welding a first member and a second member. The first member includes a first base portion extending along an edge on a second member side of the first member, and a first welded portion protruding from the first base portion toward the second member side. The second member includes a second base portion extending along an edge on a first member side of the second member and arranged to face the first base portion, and a second welded portion protruding from the second base portion toward the first member side and having a distal end vibration welded to a distal end of the first welded portion. A width of the first welded portion is larger than a width of the second welded portion. The first member has a rib for covering the first welded portion and the second welded portion from the side, and the rib is formed so as to project from the first base portion toward the second member side at a position separated from the first welded portion.

### BRIEF DESCRIPTION OF DRAWINGS

FIG. 1 is a side view showing an entire structure of a bonded body according to a first embodiment;

FIG. 2 is a top view showing the entire structure of the bonded body according to the first embodiment;

FIG. 3 is a cross-sectional view taken along the line III-III in FIG. 2;

FIG. 4 is a diagram showing a state of the cross section of FIG. 3 immediately before a vibration welding is performed;

FIG. 5 is a diagram showing the state of the cross section of FIG. 3 while vibration welding is being performed;

FIG. 6 is a cross-sectional view of the bonded body according to a second embodiment; and

FIG. 7 is a diagram showing a state of the cross section of the bonded body according to a comparative example immediately before vibration welding is performed.

### DETAILED DESCRIPTION

Hereinafter, the present embodiments will be described with reference to the attached drawings. In order to facilitate the ease of understanding, the same reference numerals are attached to the same constituent elements in each drawing where possible, and redundant explanations are omitted.

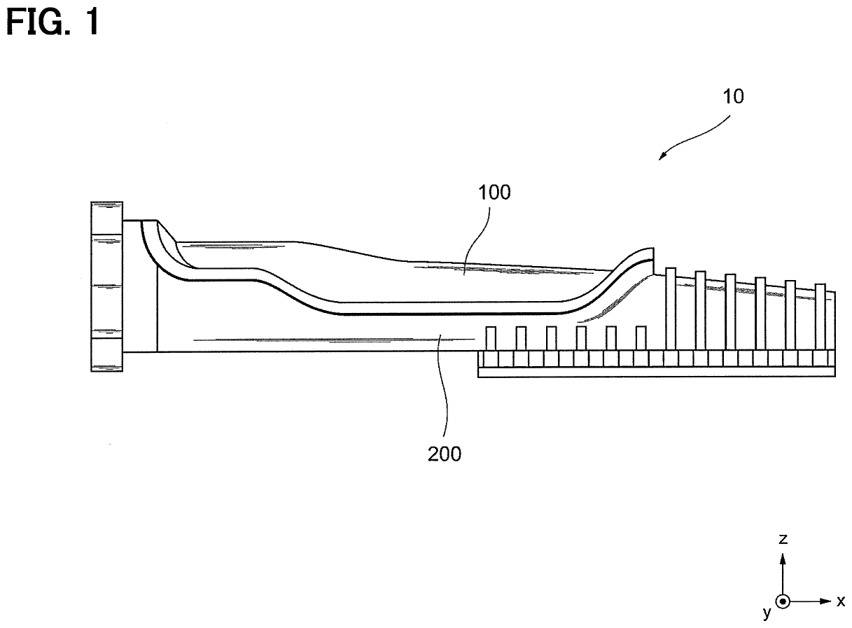

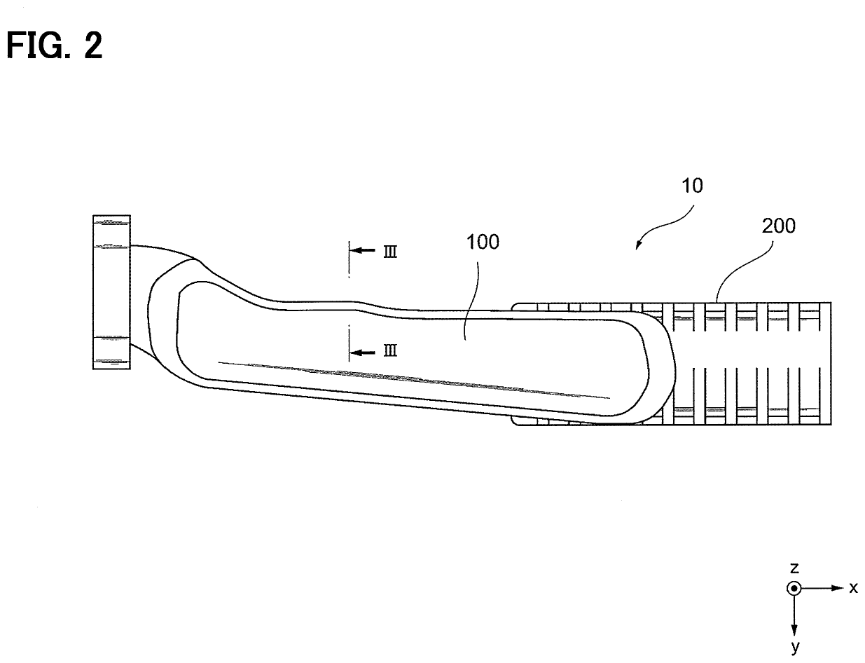

The bonded body 10 according to a first embodiment is a component that constitutes a part of an intake manifold (the whole is not shown in the figure) provided in a vehicle. As shown in FIGS. 1 and 2, the bonded body 10 is relatively complex in shape to optimize the flow of air through an interior. Therefore, the bonded body 10 is formed by vibration welding a first member 100 and a second member 200 which are previously formed by injection molding of resin.

Examples of the resin to be used as the material of the bonded body 10 include thermoplastic resins such as polyamide, polypropylene, polyphenylene sulfide, polyethylene, polybutylene terephthalate, polycarbonate, polyether ether ketone, polyetherimide, polyethylene terephthalate, polymethyl methacrylate, polyacetal, polyphenylene oxide, polystyrene, polyvinyl chloride, acrylonitrile styrene, liquid crystal polymer.

In the following description, a longitudinal direction of the bonded body 10, namely a direction from the left side to the right side in FIG. 1, is defined as a x direction, and a x axis is set along the same direction in each of the drawings. In addition, a direction perpendicular to the x direction, that is, a direction from the back side to the front side in FIG. 1 is referred to as a y direction, and a y axis is set along the same direction in each of the drawings. Furthermore, a direction perpendicular to both the x direction and the y direction, that is, the direction from the lower side to the upper side in FIG. 1 is a z direction, and a z axis is set along the same direction in each of the drawings.

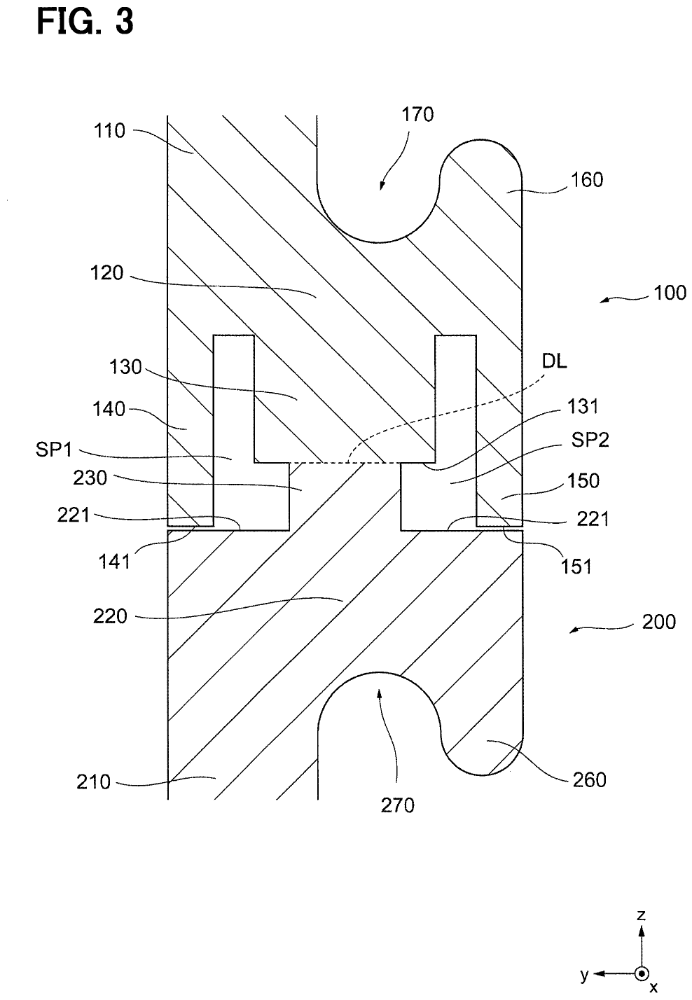

FIG. 3 schematically shows the III-III cross section of FIG. 2. First, the shape of the first member 100 will be described. As shown in FIG. 3, in a vicinity of an end portion of the first member 100 adjacent to the second member 200 side, a first pipe wall 110, a first base portion 120, a first welded portion 130, and a pair of first ribs 140, 150 are formed. The portion of the first member 100 shown in FIG. 3 is also referred to as a “bonding portion” which is connected to the second member 200.

The first pipe wall 110 is a wall that forms an air passage through which air passes, and occupies most of the first member 100.

The first base portion 120 is formed so as to protrude from the end of the first pipe wall 110 closest to the second member 200 toward the outer side (the -y direction side in FIG. 3) of the bonded body 10. The first base portion 120 is formed so as to extend along the edge on the second member 200 side of the first member 100 (along the x-axis in FIG. 3). Here, the “edge on the second member 200 side” refers to the end on the second member 200 side of the first pipe wall 110.

A first projecting portion 160 projecting toward the z direction side is formed at an end portion on the-y direction side of the first base portion 120. Thus, a first recess 170 is formed between the first projecting portion 160 and the first pipe wall 110 so as to recede in the -z direction. The first recess 170 receives a jig for fixing the first member 100 to a welding device (not shown) when the vibration welding to be described later is performed.

The first welded portion 130 is formed to protrude from the first base portion 120 toward the second member 200 side (the -z direction side). A second welded portion 230 (to be described later) of the second member 200 is joined to the distal end surface 131 of the first welded portion 130 by the vibration welding. In FIG. 3, a joint surface for vibration welding, that is, a surface which is substantially a boundary between the first welded portion 130 and the second welded portion 230 is indicated by a dotted line DL.

The first rib 140 is a plate-like portion formed so as to protrude from the end on the y direction side of the first base portion 120 toward the second member 200 (the -z direction side). The first rib 140 is formed so as to cover the first welded portion 130 and the second welded portion 230 which are bonded to each other from the side (the y direction side). The distal end surface 141 of the first rib 140 faces the end surface 221 on the z direction side of the second member 200, and a slight gap is formed between the distal end surface 141 and the end surface 221. The first rib 140 is formed at a position separated from the first welded portion 130 in the y direction. Therefore, a space SP1 is formed inside the first rib 140. Alternatively, the distal end surface 141 of the first rib 140 may be in contact with the end surface 221.

The first rib 150 is a plate-like portion formed so as to protrude from the end on the -y direction side of the first base portion 120 toward the second member 200 (the -z direction side). The first rib 150 is formed so as to cover the first welded portion 130 and the second welded portion 230 which are bonded to each other from the side (the -y direction side). The distal end surface 151 of the first rib 150 faces the end surface 221 of the second member 200, and a slight gap is formed between the distal end surface 151 and the end surface 221. The first rib 150 is formed at a position separated from the first welded portion 130 in the -y direction. Therefore, a space SP2 is formed inside the first rib 150. Alternatively, the distal end surface 151 of the first rib 150 may be in contact with the end surface 221.

Subsequently, the shape of the second member 200 will be described with reference to FIG. 3. A second pipe wall 210, a second base portion 220, and a second welded portion 230 are formed in the vicinity of the end of the second member 200 on the first member 100 side. The portion of the second member 200 shown in FIG. 3 is also referred to as a “bonding portion” which is connected to the first member 100.

The second pipe wall 210 is a wall that forms an air passage through which air passes, and occupies most of the second member 200.

The second base portion 220 is formed so as to protrude from the end of the second pipe wall 210 closest to the first member 100 toward the outer side (the -y direction side in FIG. 3) of the bonded body 10. The second base portion 220 is disposed to face the first base portion 120 described above. The second base portion 220 is formed so as to extend along the edge on the first member 100 side of the second member 200 (along the x-axis in FIG. 3). Here, the “edge on the first member 100 side” refers to the end on the first member 100 side of the second pipe wall 210.

The distal end surface 141 of the first rib 140 and the distal end surface 151 of the first rib 150 are opposed to the end surface 221 on the z direction side of the second base portion 220.

A second projecting portion 260 projecting toward the -z direction side is formed at an end portion on the-y direction side of the second base portion 220. Thus, a second recess 270 is formed between the second projecting portion 260 and the second pipe wall 210 so as to recede in the -z direction. The second recess 270 receives a jig for fixing the second member 200 to a welding device (not shown) when the vibration welding to be described later is performed.

The second welded portion 230 is formed to protrude from the second base portion 220 toward the first member 100 side (the z direction side). The end portion on the z direction side of the second welded portion 230 is joined to the distal end surface 131 of the first welded portion 130 by the vibration welding, as described above. The width (dimension along the y-axis) of the second welded portion 230 in the cross section of FIG. 3 is smaller than the width (dimension along the y axis) of the first welded portion 130 in the same cross section of FIG.3. Further, the center of the second welded portion 230 in the y direction is substantially coincident with the center of the first welded portion 130 in the same direction.

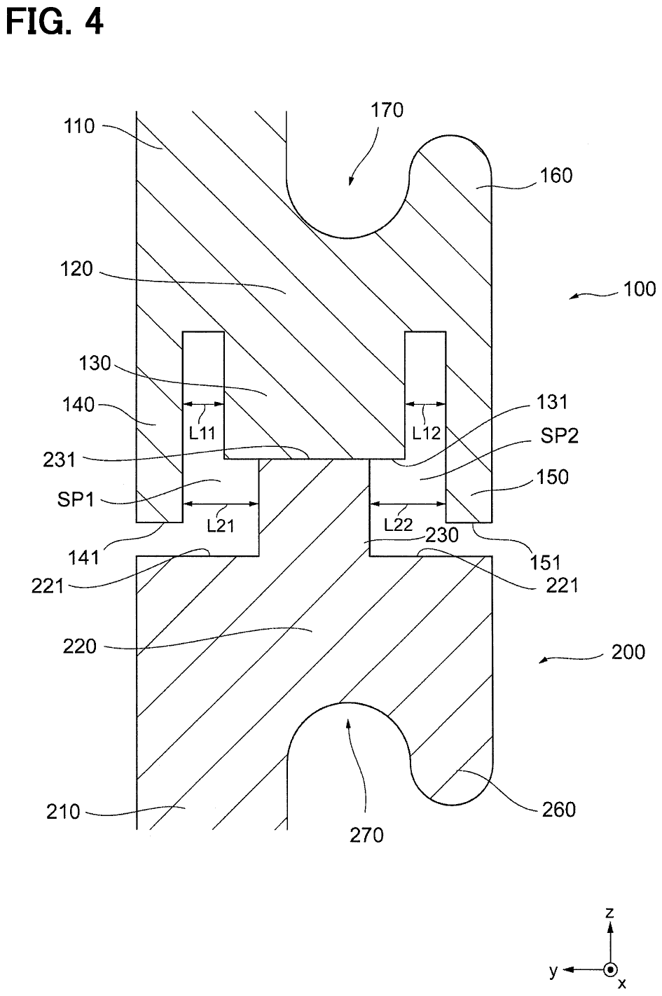

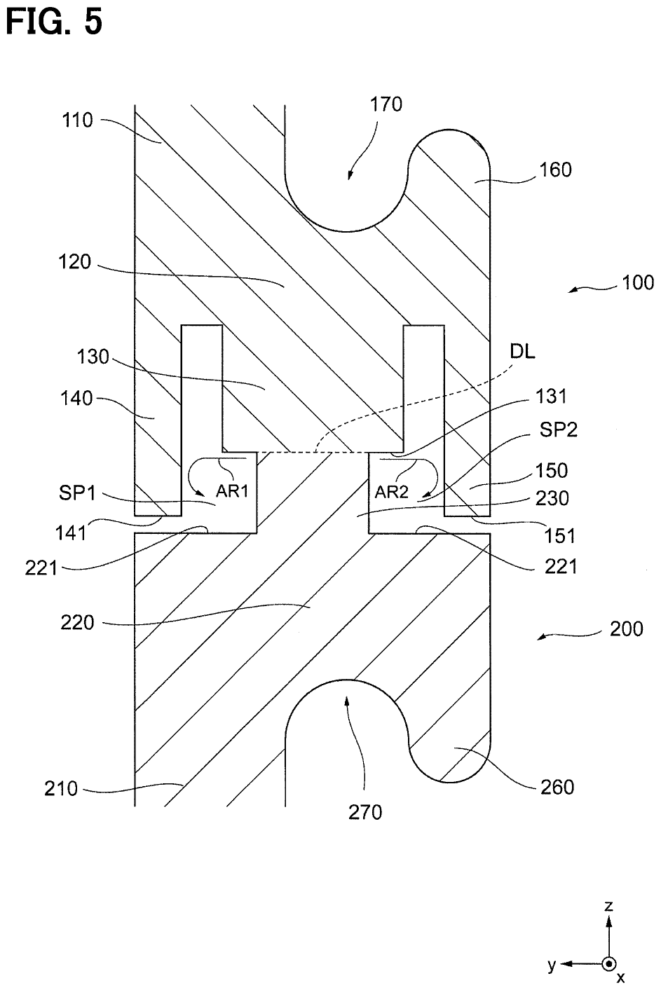

A process in which the first member 100 and the second member 200 are joined by the vibration welding will be described with reference to FIGS. 4 and 5.

FIG. 4 shows a state in the cross section of FIG. 3 immediately before vibration welding is performed. At this time, the distal end surface 231 of the second welded portion 230 is in contact with the distal end surface 131 of the first welded portion 130. Although the first member 100 and the second member 200 arranged as shown in FIG. 4 are held by the jig of the welding device, the welding device and the jig are not shown in FIG. 4.

Before the vibration welding is performed, the dimension of the second welded portion 230 along the z direction is larger than the dimension shown in FIG. 3. Therefore, as shown in FIG. 4, the distal end surface 141 of the first rib 140 and the end surface 221 of the second base portion 220 are spaced apart from each other. Similarly, the distal end surface 151 of the first rib 150 and the end surface 221 of the second base portion 220 are also spaced apart from each other.

When the vibration welding is started, the vibration is applied to at least one of the first member 100 or the second member 200. The direction of the vibration is a direction along the y axis. Therefore, the relative positional relationship along the y direction between the first member 100 and the second member 200 periodically changes due to the above-mentioned vibration.

At this time, since frictional heat is generated between the first welded portion 130 and the second welded portion 230 which are vibrating in a state of being in contact with each other, each of the contact portions are melted by the frictional heat. The length of the second welded portion 230 is gradually shortened by being pressed against the first welded portion 130 in a state in which the distal portion is melted. FIG. 5 shows a state during the vibration welding. As the first welded portion 130 and the second welded portion 230 are melted together, the distance between the distal end surface 141 and the end surface 221 and the distance between the distal end surface 151 and the end surface 221 are both gradually decreased.

In the present embodiment, as described above, the width of the second welded portion 230 is smaller than the width of the first welded portion 130. Therefore, while the vibration welding is being performed, the entire distal end surface 231 of the second welded portion 230 is always in contact with the distal end surface 131 of the first welded portion 130. Thereby, it is prevented that a bonding failure arises near an outer peripheral part of the joint portion.

When the vibration welding is performed, a part of the resin melted by the frictional heat becomes burr and grows so as to extend outward from the contact portion. The extending direction of the burr is the direction of the vibration applied to the first member 100 or the like (that is, the direction along the y axis).

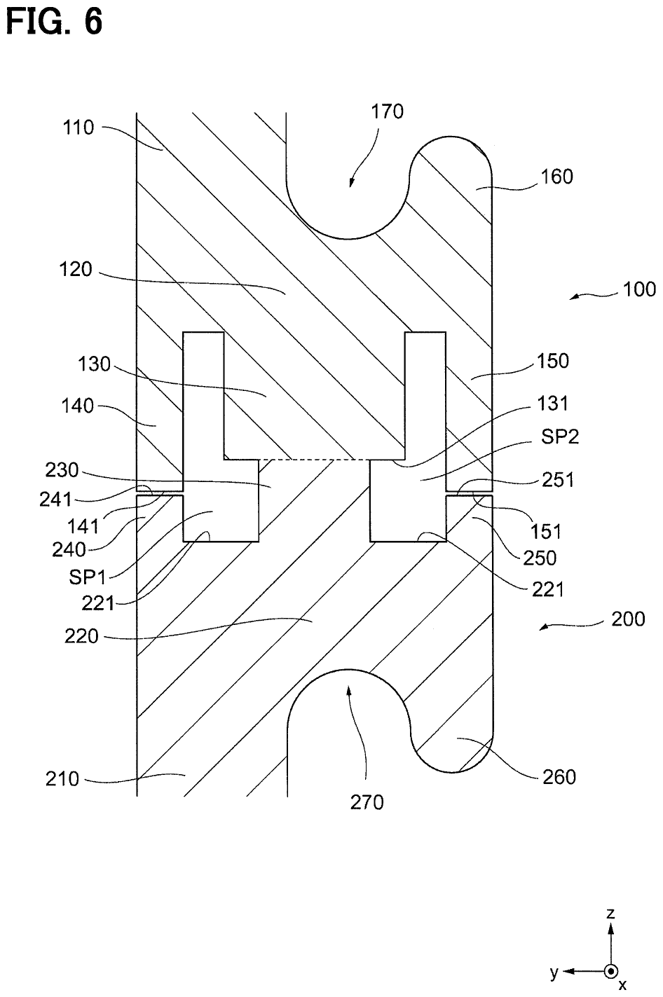

In FIG. 5, the direction in which the burr grows in the space SP1 is indicated by an arrow AR1. Further, the direction in which the burr grows in the space SP2 is indicated by an arrow AR2. The burr grown in the space SP1 extends along the y direction from the contact portion, and then the burr hits the first rib 140 to change the direction. Therefore, the burr does not come out of the space SP1 and is stored in the space SP1. Similarly, the burr grown in the space SP21 extends along the -y direction from the contact portion, and then the burr hits the first rib 150 to change the direction. Therefore, the burr does not come out of the space SP2 and is stored in the space SP2. In FIG. 3, the illustration of the burrs accommodated in the spaces SP1 and SP2 is omitted. The same applies to FIG. 6 described later.

It is preferable that the size of the gap formed between the distal end surface 141 of the first rib 140 and the second member 200 is such that the burr in the space SP1 does not protrude to the outside. Similarly, it is preferable that the size of the gap formed between the distal end surface 151 of the second rib 150 and the second member 200 is such that the burr in the space SP2 does not protrude to the outside. The first welded portion 130 and the second welded portion 230 are integrally formed by being pressed against each other in a state in which the respective distal end surface is melted. When the vibration is stopped, the resin melted by the frictional heat returns to a solid state, and the first welded portion 130 and the second welded portion 230 are bonded to each other.

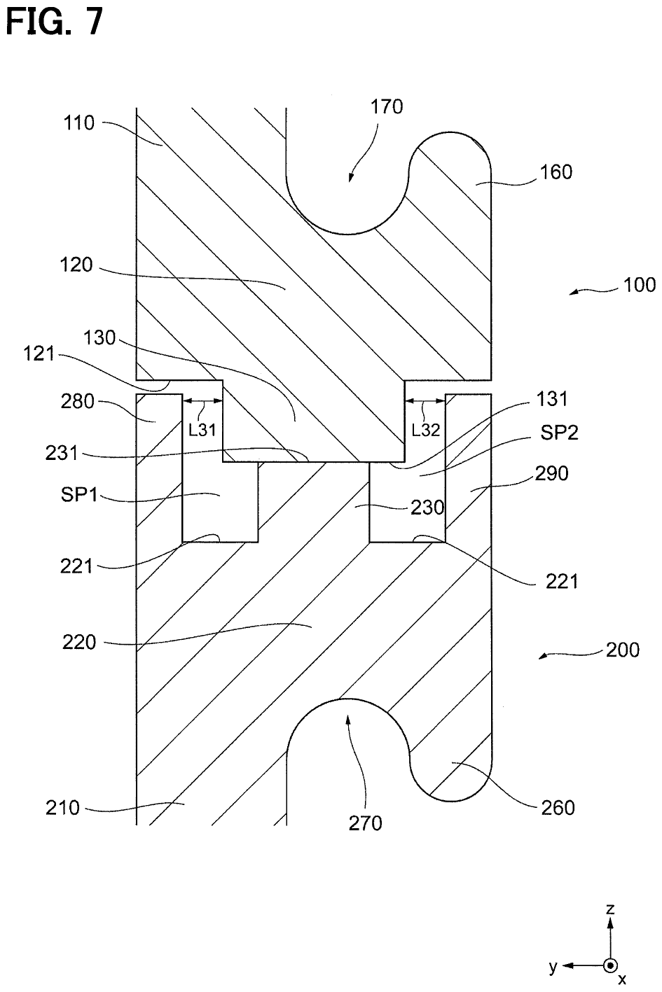

In order to explain the effect of the configuration in which the first member 100 and the second member 200 according to the present embodiment are formed as described above, a comparative example shown in FIG. 7 is explained. In FIG. 7, the first member 100 and the second member 200 according to the comparative example are fixed to a welding device (not shown), and FIG. 7 shows a state (that is, a state corresponding to FIG. 4) just before the vibration is performed.

In this comparative example, the ribs 280 and 290 covering the first welded portion 130 and the second welded portion 230 from the side are formed not in the first member 100 but in the second member 200, and in this respect, the comparative example is different from the present.

When the vibration welding is started from the state shown in FIG. 7, the distance L31 between the side surface of the first welded portion 130 and the rib 280 periodically changes. In other words, the state in which the side surface of the first welded portion 130 approaches the rib 280 and the state in which the side surface of the first welded portion 130 is away from the rib 280 are repeated. Similarly, when the vibration welding is started, the distance L32 between the side surface of the first welded portion 130 and the rib 290 periodically changes. In other words, the state in which the side surface of the first welded portion 130 approaches the rib 290 and the state in which the side surface of the first welded portion 130 is away from the rib 290 are repeated.

In this comparative example, the portion where the distance to the ribs 280 and 290 varies as described above is the first welded portion 130 having the wide width. Therefore, the distances L31 and L32 are small from the beginning. In order to reduce the size of the bonded body having such a configuration, it is necessary to further reduce the distances L31 and L32, and in this case, there is a concern that the first welded portion 130 and the ribs 280 and 290 may interfere with each other. When both of them interfere with each other, the movable range (that is, the amplitude of the vibration) at the time of the vibration welding may be reduced, and there is possibility that the bonding strength between the first member 100 and the second member 200 may be lowered.

As described above, in the comparative example, the ribs 280 and 290 are formed on the second member 200 having the second welded portion 230 having a narrow width, so that the movable range of the vibration is reduced. Therefore, it is difficult to reduce the distances L31 and L32 in order to further reduce the size.

On the other hand, in the first member 100 and the second member 200 according to the present embodiment, the first ribs 140 and 150 are formed in the first member 100 having the first welded portion 130 having a wide width. Therefore, as shown in FIG. 4, the distance L11 between the first welded portion 130 and the first rib 140 and the distance L12 between the first welded portion 130 and the first rib 150 are both relatively small. However, since the distances L11 and L12 do not change due to vibration, the first welded portion 130 and the first ribs 140 and 150 do not interfere with each other. Therefore, the distances L11 and L12 can be further reduced in order to reduce the size of the bonded body 10.

When the vibration welding is started from the state shown in FIG. 4, the distance L21 between the side surface of the second welded portion 230 and the first rib 140 periodically changes. In other words, the state in which the side surface of the second welded portion 230 approaches the first rib 140 and the state in which the side surface of the second welded portion 230 is away from the first rib 140 are repeated. Similarly, after the vibration welding is started, the distance L22 between the side surface of the second welded portion 230 and the first rib 150 periodically changes. In other words, the state in which the side surface of the second welded portion 230 approaches the first rib 150 and the state in which the side surface of the second welded portion 230 is away from the first rib 150 are repeated.

In the present embodiment, the portion where the distance to the first ribs 140 and 150 varies as described above is the second welded portion 230 having a narrow width. Therefore, the distances L21 and L22 are relatively large. As a result, the situation where the second welded portion 230 and the first ribs 140 and 150 interfere with each other is less likely to occur than in the comparative example shown in FIG. 7.

When the distances L11 and L12 are reduced as described above in order to reduce the size of the bonded body 10, the distances L21 and L22 are also reduced. However, since the distances L21 and L22 are originally relatively large as described above, it is possible to maintain a state in which interference can not occur while reducing the distances L21 and L22. In this case, it should be noted that the dimensional tolerance of each part and the amplitude of vibration should be taken into consideration so as not to cause the interference.

In the present embodiment, since the movable range at the time of the vibration welding is sufficiently secured, it is possible to reduce the size of the entire bonded body 10 while preventing a bonding strength from being lowered. When the bonded body 10 is used as a part of an intake manifold as in the present embodiment, the cross-sectional area of the air flow passage can be increased by reducing the size of the joint portion of the bonded body 10. Thereby, the pressure loss of the intake air can be reduced and the output of the engine can be improved.

In the present embodiment, two ribs (first ribs 140 and 150) are formed so as to sandwich the first welded portion 130 therebetween, but only one of the first rib 140 and the first rib 150 may be provided, and the other rib may not be provided. For example, in order to hide the burr formed in the welded portion to enhance the design of the bonded body 10, the first rib 150 may be provided on the outer side, and the first rib 140 may not be provided on the inner side. In addition, when the burr generated in the welded portion is prevented from falling into the inside of the bonded body 10 (that is, the air passage), the first rib 140 is provided on the inner side, and the first rib 150 may not be provided on the outer side.

A second embodiment will be described with reference to FIG. 6. The present embodiment is different from the first embodiment in that ribs (second ribs 240 and 250) are provided also in the second member 200 in addition to the ribs being provided in the first member 100. Hereinafter, only parts different from the first embodiment will be described, and description of parts common to the first embodiment will be omitted for explanation as appropriate.

The second rib 240 is a plate-like portion formed so as to protrude from the end on the y direction side of the second base portion 220 toward the first member 100 (the z direction side). The second rib 240 is formed so as to cover a part of the second welded portion 230 from the side (the y direction side). The distal end surface 241 of the second rib 240 faces the distal end surface 141 of the first rib 140 provided on the first member 100, and a slight gap between the distal end surface 241 and the distal end surface 141 is formed. The second rib 240 is formed at a position separated from the second welded portion 230 in the y direction. Therefore, the space SP1 is a space formed inside each of the first rib 140 and the second rib 240. Since the distal end surface 241 and the distal end surface 141 face each other in a state where they are close to each other, the burr contained in the space SP1 is not visually recognized from the outside.

It is preferable that the size of the gap formed between the distal end surface 241 and the distal end surface 141 is such that the burr in the space SP1 does not protrude to the outside. The distal end surface 241 and the distal end surface 141 may be in contact with each other.

The second rib 250 is a plate-like portion formed so as to protrude from the end on the -y direction side of the second base portion 220 toward the first member 100 (the z direction side). The second rib 250 is formed so as to cover a part of the second welded portion 230 from the side (the -y direction side). The distal end surface 251 of the second rib 250 faces the distal end surface 151 of the first rib 150 provided on the first member 100, and a slight gap between the distal end surface 251 and the distal end surface 151 is formed. The second rib 250 is formed at a position separated from the second welded portion 230 in the -y direction. Therefore, the space SP2 is a space formed inside each of the first rib 150 and the second rib 250. Since the distal end surface 251 and the distal end surface 151 face each other in a state where they are close to each other, the burr contained in the space SP2 is not visually recognized from the outside.

It is preferable that the size of the gap formed between the distal end surface 251 and the distal end surface 151 is such that the burr in the space

SP2 does not protrude to the outside. The distal end surface 251 and the distal end surface 151 may be in contact with each other.

Also in such a configuration according to the second embodiment, the same effects as those described in the first embodiment can be obtained. Further, in the above configuration, the length of each of the first ribs 140 and 150 can be made shorter than those of the first embodiment. According to such a configuration, the strength of the first ribs 140, 150 can be increased.

In the present embodiment, two ribs (second ribs 240 and 250) are formed so as to sandwich the second welded portion 230 therebetween, but only one of the second rib 240 and the second rib 250 may be provided, and the other rib may not be provided. For example, in order to hide the burr formed in the welded portion to enhance the design of the bonded body 10, the first rib 150 and the second rib 250 may be provided on the outer side, and the first rib 140 and the second rib 240 may not be provided on the inner side. In addition, when the burr generated in the welded portion is prevented from falling into the inside of the bonded body 10 (that is, the air passage), the first rib 140 and the second rib 240 are provided on the inner side, and the first rib 150 and the second rib 250 may not be provided on the outer side.

The embodiments have been described with reference to specific examples above. However, the present disclosure is not limited to these specific examples. Those skilled in the art appropriately design modifications to these specific examples, which are also included in the scope of the present disclosure as long as they have the features of the present disclosure. The elements, the arrangement, the conditions, the shape, etc. of the specific examples described above are not limited to those exemplified and can be appropriately modified. The combinations of elements included in each of the above described specific examples can be appropriately modified as long as no technical inconsistency occurs.

In an assumable example where a product having a relatively complicated shape is formed by resin such as an intake manifold, a plurality of members are formed in advance, and the product (bonded body) is formed by vibration welding these members. The intake manifold has a structure in which two divided members each having a protruding portion formed on part thereof are subjected to vibration welding in a state in which the distal ends of the protruding portions are bonded to each other.

When the vibration welding is performed, it is known that burrs occur at the welded portion, and that the burrs grow gradually. In order to prevent part of the burr from peeling off and falling into or around the product, the above intake manifold has a rib (cover wall) that covers the periphery of the welded portion. The rib is previously formed on at least one of the divided members before the vibration welding is performed. In addition, the above ribs may be provided for the purpose of concealing the welded portion and improving a design.

For convenience of explanation, in the following, one of the members to be vibration welded is referred to as a “first member”, and the other is referred to as a “second member”. Further, a portion of the first member which protrudes toward the second member and whose distal end is vibration-welded is hereinafter referred to as a “first welded portion”. Furthermore, a portion of the second member that protrudes toward the first member and whose distal end is vibration welded is hereinafter referred to as a “second welded portion”.

In the intake manifold, a width of the first welded portion is larger than a width of the second welded portion. In such a configuration, the vibration welding can be performed while maintaining a state in which an entire distal end surface of the second welded portion is always in contact with the distal end surface of the first welded portion. Thereby, it is prevented that a bonding failure arises near an outer peripheral part of the joint portion.

The rib of the intake manifold described above is provided on the second member, and is provided so as to cover the first welded portion and the second welded portion from the side. When the vibration welding is performed, a state in which the side surface of the first welded portion is close to the rib and a state in which the side surface of the first welded portion is moved away from the rib are repeated due to the vibration of the member.

In order to reduce the size of the product (bonded body), it is preferable to make the distance between the first welded portion and the rib as small as possible. However, if the distance is too small, the movable range (that is, the amplitude of the vibration) at the time of vibration welding becomes smaller due to the interference between the two members, so that there is a possibility that the bonding strength between the first member and the second member is lowered.

In particular, in the intake manifold, the width of the first welded portion on the first member having no rib is increased, and as a result, the distance between the first welded portion and the rib is reduced from the beginning. Therefore, it is difficult to further miniaturize the product by reducing the distance.

It is an object of the present disclosure to provide a bonded body that is capable of sufficiently securing a movable range during vibration welding and that can reduce an overall size while preventing a decrease in bonding strength.

The bonded body according to the present disclosure is a bonded body (10) formed by vibration welding a first member (100) and a second member (200). The first member includes a first base portion (120) extending along an edge on a second member side of the first member, and a first welded portion (130) protruding from the first base portion toward the second member side. The second member includes a second base portion (220) extending along an edge on a first member side of the second member and arranged to face the first base portion, and a second welded portion (230) protruding from the second base portion toward the first member side and having a distal end vibration welded to a distal end of the first welded portion. A width of the first welded portion is larger than a width of the second welded portion. The first member has a rib (140, 150) for covering the first welded portion and the second welded portion from the side, and the rib is formed so as to protrude from the first base portion toward the second member side at a position separated from the first welded portion.

In the bonded body having such a configuration, the width of the first welded portion is larger than the width of the second welded portion. Therefore, in the case of vibration welding, the entire distal end surface of the second welded portion is always in contact with the distal end surface of the first welded portion. Thereby, it is prevented that a bonding failure arises near an outer peripheral part of the joint portion.

Moreover, the rib which covers the first welded portion and the second welded portion from the side is provided on the first member which has the first welded portion having a wider width in comparison with the second welded portion. Therefore, the distance between the first weld portion and the rib is small, but since the distance does not change due to vibration, the first weld portion and the rib do not interfere with each other. Therefore, the distance can be further reduced in order to miniaturize the bonded body.

On the other hand, since the width of the second welded portion is narrow, the distance between the second welded portion and the rib is relatively large. Therefore, as described above, even when the distance between the first welded portion and the rib is reduced to miniaturize the overall size, the distance between the second welded portion and the rib does not become too small. Since the movable range at the time of vibration welding is sufficiently secured, it is possible to miniaturize the entire bonded body while preventing a bonding strength from being lowered.

The present disclosure provides a bonded body that is capable of sufficiently securing a movable range during vibration welding and that can reduce an overall size while preventing a decrease in bonding strength.

1. A bonded body, comprising:
a first member; and
a second member performing a vibration welding with the first member so as to form the bonded body, wherein
the first member includes
a first base portion extending along an edge on the second member side of the first member, and
a first welded portion protruding from the first base portion toward a second member side,
the second member includes
a second base portion extending along an edge on the first member side of the second member and disposed to face the first base portion, and
a second welded portion protruding from the second base portion toward a first member side and having a distal end which is vibration welded to the distal end of the first welded portion,
a width of the first welded portion is larger than the width of the second welded portion,
the first member includes a rib covering the first welded portion and the second welded portion from the side, and projecting from the first base portion toward the second member at a position separated from the first welded portion.

2. The bonded body according to claim 1, wherein
the two ribs are formed so as to sandwich the first welded portion therebetween.

3. The bonded body according to claim 1, wherein
the rib is a first rib, and
the second member has a second rib covering the second welded portion from the side and projecting from the second base portion toward the first member at a position separated from the second welded portion.

4. The bonded body according to claim 3, wherein
two of the first ribs are provided so as to sandwich the first welded portion therebetween, and
two of the second ribs are provided so as to sandwich the second welded portion therebetween.

5. The bonded body according to claim 3, wherein
a distal end of the first rib and a distal end of the second rib are opposed to each other.

6. The bonded body according to claim 3, wherein
a space is formed inside the first rib so that a burr generated due to the vibration welding hits the first rib to change the direction, and is stored in the space.
